(19) United States
(12) Patent Application Publication
(10) Pub. No.: US 2008/0155644 A1
(43) Pub. Date: Jun. 26, 2008

(54) METHOD AND SYSTEM FOR COMMUNICATING IN A GROUP OF COMMUNICATION DEVICES

(75) Inventors: Sergey N. Baranov, St. Petersburg (RU); Michael L. Charlier, Palatine, IL (US); Chung-Kwang Chou, Plantation, FL (US); Thomas J. Walczak, Woodstock, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/616,120

(22) Filed: Dec. 26, 2006

(51) Int. Cl. G06F 17/00; G06F 21/00

(52) U.S. Cl. 726/1

(57) ABSTRACT

A method (400) and system for communicating in a group of communication devices is disclosed. The method at a first communication device (104) includes receiving (404) a first trust level change request from a second communication device (108). The first trust level is associated with the first communication device and the second communication device (108). Further, a group trust level is associated with the group of communication devices. Further, the method includes modifying (406) the first trust level based on historical data associated with the first communication device and the second communication device. The historical data is a function of at least one of duration of communication, frequency of the communication, and content of data exchanged, between the first communication device and the second communication device.

### FIELD OF THE INVENTION

The present invention generally relates to the field of communication networks, and more particularly, to a method and system for communicating in a group of communication devices.

### BACKGROUND

A communication network consists of a group of communication devices that are connected together through wired or wireless connections. Examples of communication networks include, but are not limited to, wired/wireless Local Area Networks (LAN), Metropolitan Area Networks (MAN), Wide Area Networks (WAN), ad-hoc networks, the Internet, Public Switched Telephone Networks (PSTN), peer to peer networks, and the like. The communication networks facilitate data exchange, data sharing and communication among the group of communication devices. Examples of the communication devices include, but are not limited to, mobile phones, personal digital assistants (PDAs), laptops, and desktop computers. These communication networks are employed at various locations such as businesses localities, government offices, schools, colleges, public places, or homes. However, the data available in a communication network can be accessed, manipulated and deleted by unauthorized personnel. For example, data regarding credit cards transactions of a user can be misused by unauthorized personnel if necessary measures are not taken for securing these transactions. Hence, secure communication regarding processing of transactions in the communication networks is a major area of concern as more and more people are relying on these communication networks for carrying out important transactions.

Currently, there exist various methods that address the issue of security in the communication networks. One of these methods is targeted towards secured E-commerce transactions. The method involves authentication of each communication device of the group of communication devices. The authentication process takes place when a communication device is involved in processing of a transaction. The method involves encrypting the data related to this transaction while the transaction is being processed. The method involves securely collecting, storing, and transmitting information regarding this transaction.

Another method that addresses the issue of security involves a distributed security system for communication devices in a network. Each of these communication devices is responsible for generating, distributing and controlling its keys for access to the network. These keys are used by these communication devices to establish a trusted network. The method also involves checking of each communication device's membership to the trusted network by other communication devices. This checking of the communication devices determines the communication devices that are allowed to access the network and communicate in the trusted network.

However, the above discussed methods have one or more of the following limitations. One of these methods is not useful for communication groups that communicate on a regular basis. In other words, this method is not applicable for social networking groups. In another method, communication and exchange of data takes place at a particular, common level of trust for all the communication devices in the trusted network. The level of trust is established during the formation of the trusted network and is not subject to change after the formation of the trusted network. If a new communication device joins the trusted network, the level of trust remains unchanged, and the communication devices communicate with the new communication device at the same level of trust.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and to explain various principles and advantages, all in accordance with the present invention.

FIG. 1 illustrates an exemplary communication system, where various embodiments of the present invention can be practiced;

FIG. 2 illustrates a block diagram of a first communication device, in accordance with an embodiment of the present invention;

FIG. 3 illustrates a block diagram of a server, in accordance with an embodiment of the present invention;

FIG. 4 is a flow diagram illustrating a method for communicating in a group of communication devices in a network, in accordance with an embodiment of the present invention; and

FIG. 5 is another flow diagram illustrating a method for communicating in a group of communication devices in a network, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for communicating in a group of communication devices, in accordance with various embodiments of the present invention, it should be observed that the present invention utilizes a combination of method steps and apparatus components related to the method and system for communicating in the group of communication devices. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art having the benefit of the description herein.

In this document, the terms ‘comprises’, ‘comprising’, ‘includes’, ‘including’, or any other variation thereof, are intended to cover a non-exclusive inclusion, such that a process, article, system or apparatus that comprises a list of elements does not include only those elements but may include other elements, not expressly listed or inherent to such a process, article or apparatus. An element proceeded by ‘comprises . . . a’ does not, without more constraints, preclude the existence of additional identical elements in the process, article, system or apparatus that comprises the element. The terms ‘includes’ and/or ‘having’, as used herein, are defined as comprising.

The term ‘another’, as used in this document, is defined as at least a second or more. The term ‘includes’, as used herein, is defined as comprising.

The term ‘social group’, as used in this document, encompasses an affinitive group or a social networking group. It should be apparent to a person ordinarily skilled in the art that the description covered in this document with respect to social groups can be exemplified for affinitive groups and various social networking groups as well.

For one embodiment, a method for communicating in a group of communication devices in a network is provided. The method at a first communication device includes receiving a first trust level change request from a second communication device. The first trust level is associated with the first communication device and the second communication device. A group trust level is associated with the group of communication devices. The method also includes modifying the first trust level, based on historical data associated with the first communication device and the second communication device. The historical data is a function of at least the duration of communication, the frequency of the communication, and/or the content of data exchanged between the first communication device and the second communication device.

For another embodiment, a first communication device is provided. The first communication device includes a receiver that is configured to receive a first trust level change request from a second communication device from a group of communication devices. The first trust level is associated with the first communication device and the second communication device. The first communication device also includes a processor that is operatively coupled to the receiver. The processor is configured to modify the first trust level, based on historical data associated with the first communication device and the second communication device. The historical data is a function of at least the duration of communication, the frequency of the communication, and/or the content of data exchanged between the first communication device and the second communication device. Moreover, the first communication device includes a transmitter that is operatively coupled to the processor. The transmitter is configured to send a request to a third communication device to update a group trust level associated with the group of communication devices.

For yet another embodiment, a server for managing communication in a group of communication devices in a network is provided. The server includes a receiver that is configured to receive a group trust level change request from a first communication device. The group trust level is associated with the group of communication devices. The group trust level change request is generated by the first communication device, based on historical data associated with the first communication device and a second communication device. This historical data is a function of at least the duration of communication, the frequency of the communication, and/or the content of data exchanged between the first communication device and the second communication device. Further, the server includes a processor that is operatively coupled to the receiver. The processor is configured to update the group trust level, based on a comparison of individual trust levels associated among the group of communication devices. Furthermore, the server includes a transmitter that is operatively coupled to the processor. The transmitter is configured to broadcast the updated group trust level to the group of communication devices.

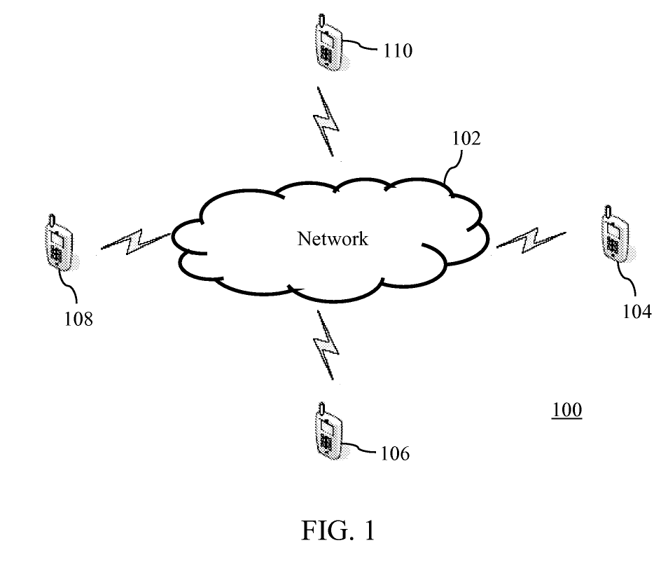

FIG. 1 illustrates an exemplary communication system 100, where various embodiments of the present invention can be practiced. The communication system 100 includes a network 102. Examples of the network 102 include, but are not limited to, Local Area Networks (LANs), Wide Area Networks (WANs), Metropolitan Area Networks (MANs), peer-to-peer networks, Wi-Fi ad-hoc networks, Wi-Fi fixed networks, IEEE 802.16-based broadband wireless access networks, Advanced Mobile Phone Systems (AMPS) networks, Global System for Mobile Communications (GSM) networks, Digital Cellular Systems (DCS) networks, Code Division Multiple Access (CDMA) networks, Integrated Digital Enhanced Networks (iDENs), Bluetooth™ Personal Area Networks, and Universal Mobile Telecommunications Systems (UMTS) networks. The network 102 can also be an ad-hoc network. The communication system 100 further includes a communication device 104, a communication device 106, a communication device 108, and a communication device 110. Although FIG. 1 is shown to include only the communication devices 104, 106, 108, and 110, it will be apparent to a person ordinarily skilled in the art that the network 102 can include more communication devices than shown in FIG. 1. Examples of the communication devices 104, 106, 108, and 110 include, but are not limited to, cellular phones, laptops, Personal Digital Assistants (PDAs), and pagers. The communication devices 104, 106, 108, and 110 can communicate with each other through the network 102. The network 102 can also include a server that can manage communication among the communication devices 104, 106, 108, and 110.

The communication devices 104, 106, 108, and 110 form an ad-hoc group for the purpose of communication. For examples, the communication devices 104, 106, 108, and 110 can belong to the members of a family who may regularly communicate with each other. The ad-hoc group is a dynamic network of communication devices, where the communication devices can join and leave the group in an ad-hoc manner. A communication device, for example, the communication device 106 can join an ad-hoc group based on some criteria. For example, to join an ad-hoc group that includes users belonging to a particular enterprise, the user of the communication device 106 needs to belong to that particular enterprise. Further, a communication device has to satisfy certain criteria to be part of the ad-hoc group. The nature of the communication that can place among the ad-hoc group formed by the communication devices 104, 106, 108, and 110 can depend on the knowledge these communication devices have about each other. For the purpose of discussion, the communication devices 104, 106, 108, and 110, together, will hereinafter be referred to as the group of communication devices. The group of communication devices 104, 106, 108, and 110 can be part of a social, business, or common interest group. For example, a group of music enthusiasts can form an ad-hoc group that discusses topics pertaining to the field of music.

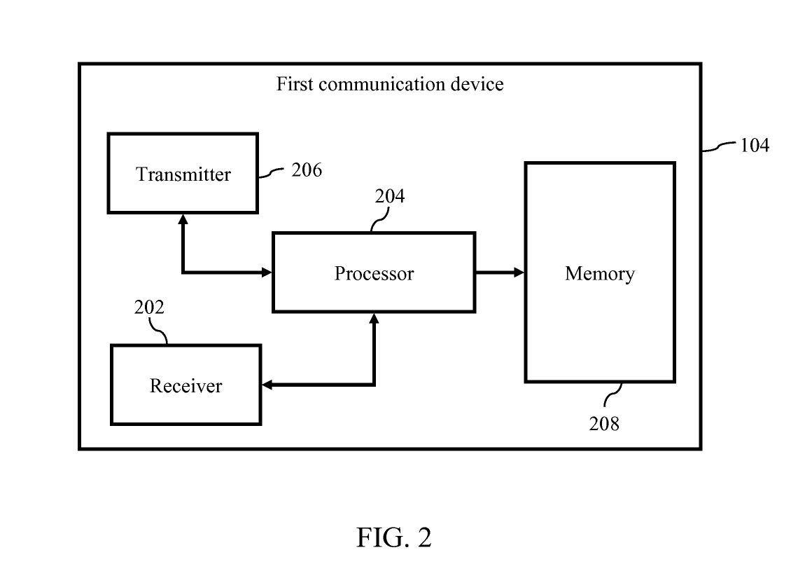

FIG. 2 is a block diagram of the communication device 104, hereinafter referred to as a first communication device 104, in accordance with an embodiment of the present invention. Those ordinarily skilled in the art would appreciate that the first communication device 104 can include all or even a fewer number of components than the components shown in FIG. 2. Further, those ordinarily skilled in the art would understand that the first communication device 104 can include additional components that are not shown here, since they are not germane to the operation of the first communication device 104, in accordance with the inventive arrangements. To describe the first communication device 104, reference will be made to FIG. 1, although it should be understood that the first communication device 104 can be implemented in any other suitable environment or network.

The first communication device 104 includes a receiver 202, a processor 204, and a transmitter 206. The receiver 202 can receive a first trust level change request from a second communication device. Hereinafter, the communication device 108 will be referred to as the second communication device 108. A trust level is a set of configurations or settings that applies to communication taking place among the group of communication devices in the ad-hoc group. The first trust level is associated with the first communication device 104 and the second communication device 108. The first trust level is based on the communication between the first communication device 104 and the second communication device 108. Each communication device has an associated trust level with every other communication device in the group of communication devices. For example, when the first communication device 104 is a mobile phone with a phone book listing of contacts, the first communication device 104 can have a trust level associated with every contact present in the phone book listing that belongs to the group of communication devices. The trust level associated with a pair of communication devices can be represented in one or more ways. For example, the trust level can be represented on a scale with a lower limit and an upper limit. For example, the trust level could vary from a lower limit of 1 to an upper limit of 5. The trust level can also be represented as binary values. For example, the trust level can have only two values, namely 0 and 1, that also mean ‘non-trusted’ and ‘trusted’ respectively. In yet another embodiment, the trust level can be represented as percentage values. For example, the trust between a pair of communication devices can be represented as 30 percent, which can indicate the level of trust between these communication devices.

The receiver 202 is operatively coupled to the processor 204. The processor 204 is configured to modify the first trust level, based on historical data associated with the first communication device 104 and the second communication device 108. The historical data is a function of at least the duration of the communication, the frequency of the communication, and/or the content of data exchanged between the first communication device 104 and the second communication device 108. For example, the historical data associated with the first communication device 104 and the second communication device 108 can depend on the duration of the communication between the first communication device 104 and the second communication device 108. The historical data can also depend on how frequently the first communication device 104 and the second communication device 108 have communicated with each other over a given period of time. Further, the historical data can depend on the nature of the content shared between the first communication device 104 and the second communication device 108 when they communicated. For example, the first communication device 104 and the second communication device 108 can share confidential information when they communicate with each other. In an embodiment, the historical data can also depend on the information exchange that takes place among the group of communication devices in the network 102.

The processor 204 is operatively coupled to the transmitter 206. The transmitter 206 is configured to send a request to a third communication device, for example, the communication device 110, to update a group trust level associated with the group of communication devices. In this case, the communication device 110 is an initiator, which initiates the formation of the ad-hoc group for the group of communication devices. The communication among the group of communication devices takes place at the group trust level. The group trust level determines the level of data sharing that is allowed for the group of communication devices. The group trust level also determines the nature of information exchange that can take place among the group of communication devices. The group trust level can be updated by the communication device 110 which is the initiator.

The receiver 202 is also configured to receive enquiry messages from the communication device 110. These enquiry messages are sent by the communication device 110 to verify the presence of the second communication device 108. In an embodiment, the receiver 202 receives the enquiry messages that are periodically sent by the communication device 110. The receiver 202 is also capable of receiving a notification of the appointment of a communication device, for example, the communication device 106, for managing the communication among the group of communication devices. The notification is generated by the communication device 110 when the communication device 110 leaves the group of communication devices. Once the communication device 106 is appointed, the communication device 106 can function as a new initiator for the group of communication devices. The receiver 202 is also capable of receiving approval messages from the group of communication devices regarding the appointment of the communication device 106 to manage the communication among the group of communication devices. In an embodiment, the receiver 202 is also configured to receive the updated group trust level broadcasted by the communication device 110.

In an embodiment, the first communication device 104 is the initiator for the group of communication devices. In this case, the first communication device 104 manages the communication among the group of communication devices. The processor 204 is configured to appoint a communication device from the group of communication devices, for example, the communication device 106 as the new initiator for managing the communication among the group of communication devices, when the first communication device 104 is the initiator. The first communication device 104 appoints the communication device 106 by receiving an approval from the group of communication devices in the form of approval messages. The processor 204 receives these approval messages since the processor 204 has to appoint a new initiator when the first communication device 104 wants to leave the group. In an embodiment, the processor 204 appoints the communication device 106 by comparing the individual trust levels among the group of communication devices. For example, the communication device 106 is appointed when the communication device 106 has the higher trust level associated among the group of communication devices as compared to the other communication devices belonging to the group of communication devices. In an embodiment, the first communication device 104 can leave the group of communication devices without giving any notice.

In an embodiment, the processor 204 is capable of analyzing the historical data available with the first communication device 104 and the second communication device 108 after a pre-defined time interval. The processor 204 can modify the first trust level, based on the analysis of the historical data, after the communication between the first communication device 104 and the second communication device 108 is over. In an embodiment, the processor 204 can modify the first trust level, based on the analysis of the historical data while the first communication device 104 and the second communication device 108 continue to communicate.

In an embodiment, the processor 204 is configured to modify the group trust level when a non-trusted communication device has joined the group of communication devices based on a query-response technique. The processor 204 can communicate with a reference communication device, for example, the communication device 110, which has previous knowledge of the non-trusted communication device that has joined the group. The processor 204 obtains this previous knowledge by querying the communication device 110. The processor 204 generates some queries that are divided into groups based on the level of details regarding the previous knowledge of the non-trusted communication device. For example, when a non-trusted communication device has joined a group of college alumni, the processor 204 can generate queries based on the level of details such as the college name, the year of joining and the field of education, which is required from the non-trusted communication device. This information is verified by questioning a reference communication device in the group that has previous knowledge of the non-trusted communication device. The processor 204 questions the communication device 110 by asking these queries. Similarly, the processor 204 receives a response from the other communication devices of the group that have previous knowledge of the non-trusted communication device. Based on the response from the communication devices in the group, the processor 204 modifies the group trust level. The modified group trust level determines the level at which the group of communication devices can communicate with the non-trusted communication device. For example, if the majority of the communication devices of the group do not have previous knowledge of the non-trusted communication device, the group trust level is lowered by the processor 204.

In an embodiment, the processor 204 is configured to establish data sharing settings for the group of communication devices, based on the group trust level. For example, the processor 204 can establish data sharing settings, based on the group trust level, such that confidential information cannot be shared within the group of communication devices.

In an embodiment, the transmitter 206 is configured to notify the group of communication devices about the appointment of the communication device 108 as the new initiator for managing communication among the group of communication devices. The transmitter 206 notifies the group of communication devices when the first communication device 104 wants to leave the group. In an embodiment, the transmitter 206 is configured to broadcast the updated group trust level to the group of communication devices.

In an embodiment, the first communication device 104 includes a memory 208, which is operatively coupled to the processor 204. The memory 208 is configured to store the historical data associated with the first communication device 104 and the second communication device 108. In an embodiment, the processor 204 is configured to establish data sharing settings for the group of communication devices, based on the group trust level.

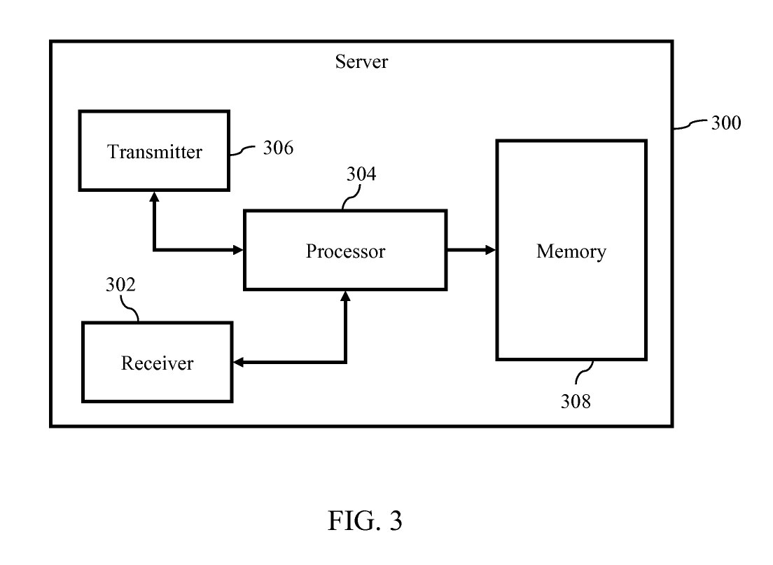

FIG. 3 is a block diagram of a server 300, in accordance with an embodiment of the present invention. To describe the server 300, reference will be made to FIG. 1, although it is understood that the server 300 can be implemented with reference to any other suitable embodiment of the present invention. The server 300 manages communication in the group of communication devices in the network 102. An example of the server 300 is a mobile centralized server.

The server 300 includes a receiver 302, a processor 304, and a transmitter 306. The receiver 302 is configured to receive a group trust level change request from the first communication device 104. A group trust level is a set of configurations and settings that applies to communication taking place among the group of communication devices in the ad-hoc group. This communication among the group of communication devices takes place at the group trust level. For example, the receiver 302 can receive the group trust level change request from the first communication device 104 when a communication device of the group of communication devices, for example, the second communication device 108 leaves the group. As a result, the group trust level may get modified. In an embodiment, the receiver 302 can receive the group trust level change request from the first communication device 104 when a communication device joins the group. The group trust level can change when individual trust levels among the group of communication devices, for example, the first trust level associated with the first communication device 104 and the second communication device 108, are modified. The group trust level change request is generated based on the historical data associated with the first communication device 104 and the second communication device 108. The historical data can be based on at least the duration of the communication, the frequency of the communication, and/or the content of data exchanged between the first communication device 104 and the second communication device 108. In an embodiment, the historical data can also depend on the information exchange that takes place between the group of communication devices and the server 300.

The receiver 302 is operatively coupled to the processor 304. The processor 304 is configured to update the group trust level based on a comparison of the individual trust levels associated among the group of communication devices. For example, the processor 304 can modify the group trust level so that confidential data is no longer allowed to be shared among the group of communication devices. The transmitter 306 is configured to broadcast the updated group trust level to the group of communication devices.

In an embodiment, the server 300 includes a memory 308. The processor 304 is operatively coupled to the memory 308. The memory 308 is configured to store the historical data associated with the group of communication devices. For example, the memory 308 stores information about the duration of the communication, the frequency of the communication, and/or the content of data exchanged among the group of communication devices.

The receiver 302 is configured to receive a request from the first communication device 104, to access the historical data. For example, the receiver 302 receives a request from the first communication device 104 to access the historical data associated with the group of communication devices and stored with the server 300, when the first communication device 104 needs to update the first trust level. The first trust level can be changed based on the communication between the first communication device 104 and the second communication device 108. In one embodiment, the first communication device 104 can request the server 300 for access to the historical data when the first communication device 104 and the second communication device 108 are communicating. In another embodiment, the first communication device 104 can request the server 300 when the communication between the first communication device 104 and the second communication device 108 is over.

In an embodiment, the processor 304 is configured to update the historical data based on the change in a first trust level associated with the first communication device 104 and the second communication device 108. In another embodiment, the processor 304 is configured to establish data sharing settings for the group of communication devices, based on the group trust level. For example, the processor 304 establishes data sharing settings for the group so that confidential data is no longer shared within the group.

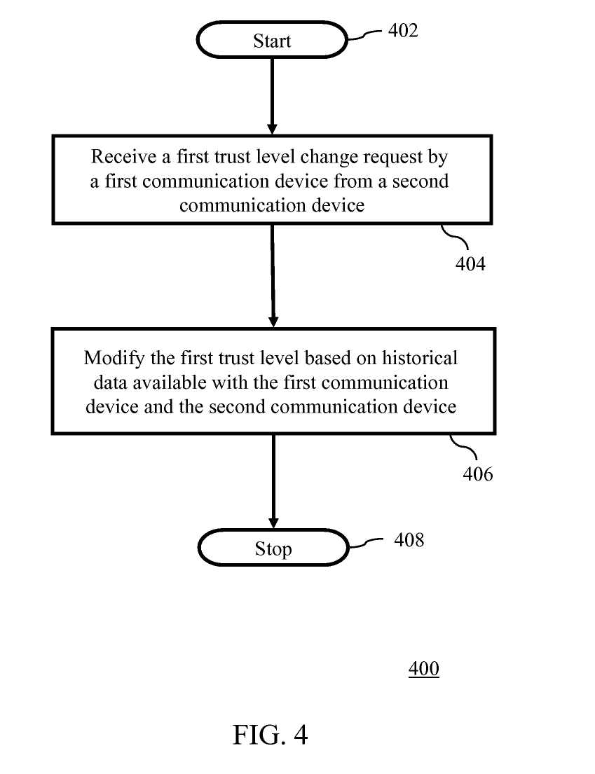

FIG. 4 is a flow diagram illustrating a method 400 for communicating in a group of communication devices in a network, in accordance with an embodiment of the present invention. At step 402, the method 400 for communicating in the group of communication devices in the network 102 is initiated. At step 404, a first trust level change request is received by a first communication device from a second communication device. A trust level is a set of configurations or settings that applies to communications taking place among the group of communication devices in an ad-hoc group. The first trust level is the set of configurations or data sharing settings associated with the first communication device and the second communication device. Further, a group trust level is associated with the group of communication devices. The group trust level determines the nature of communication among the group of communication devices in the ad-hoc group. For example, the group trust level may restrict the group of communication devices in the ad-hoc group from sharing confidential information among themselves.

At step 406, the first trust level is modified based on the historical data available with the first communication device and the second communication device. The historical data is a function of at least the duration of the communication, the frequency of the communication, and/or the content of data exchanged between the first communication device and the second communication device. The first trust level can be dynamically modified by the first communication device, for example, while the first communication device and the second communication device are communicating. The first trust level can also be modified after the communication between the first communication device and the second communication device is over. At step 408, the method 400 is terminated.

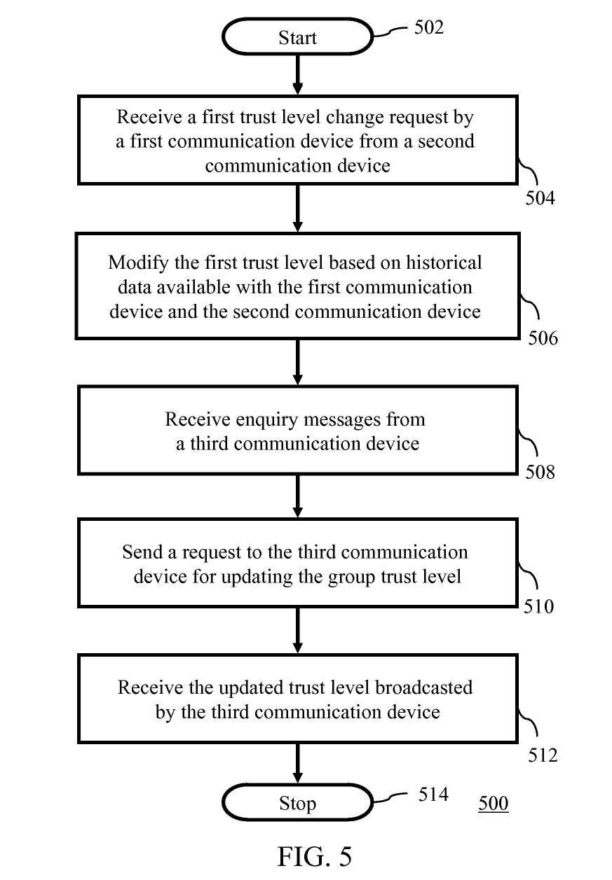

FIG. 5 is another flow diagram illustrating a method 500 for communicating in a group of communication devices in a network, in accordance with another embodiment of the present invention. To describe the method 500, reference will be made to FIGS. 1, 2 and 3, although it is understood that the method 500 can be implemented in any other suitable embodiment of the present invention. Further, the method 500 can have a greater or fewer number of steps than shown in FIG. 5.

At step 502, the method 500 for communicating in the group of communication devices in the network 102 is initiated. At step 504, a first trust level change request is received by the first communication device 104. The first trust level change request is received from the second communication device 108. A first trust level is associated with the first communication device 104 and the second communication device 108. The first trust level is the set of configurations or settings for data sharing between the first communication device 104 and the second communication device 108. The first trust level change request can be generated by the second communication device 108, based on the historical data available with the first communication device 104 and second communication device 108. A group trust level is associated with the group of communication devices. The group trust level is the set of configurations or settings for data sharing that determine the communication among the group of communication devices. In an embodiment, the first trust level change request is generated by the second communication device 108 when the second communication device 108 leaves the group of communication devices. In another embodiment, the first trust level change request is generated by the second communication device 108 when the second communication device 108 joins the group of communication devices.

At step 506, the first trust level is modified based on the historical data available with the first communication device 104 and the second communication device 108. The historical data available with the first communication device 104 and the second communication device 108 is a function of at least the duration of the communication, the frequency of the communication, and/or the content of data exchanged between the first communication device 104 and the second communication device 108. For example, when the first communication device 104 and the second communication device 108 have communicated with each other for a sufficiently longer duration of time, the first trust level can be increased. Similarly, the first trust level can be lowered when it is determined, based on the historical data, that the first communication device 104 and the second communication device 108 have not communicated frequently in the past. The first communication device 104 and the second communication device 108 can now communicate at this modified first trust level.

At step 508, enquiry messages are received by the first communication device 104 from a third communication device, for example, the communication device 110. The enquiry messages are sent by the communication device 110 to determine the presence of the second communication device 108. The communication device 110 is the initiator that initiates the formation of the ad-hoc group among the group of communication devices.

In an embodiment, the first communication device 104 is the initiator that initiates the formation of the ad-hoc group among the group of communication devices. The first communication device 104 requests the group of communication devices for the formation of the ad-hoc group. The group of communication devices broadcast their personal information to the first communication device 104. This personal information is analyzed by the first communication device 104 and is broadcasted to the group of communication devices for cross-referencing. The first communication device 104 then determines whether the group of communication devices has previous knowledge about each other. The first communication device 104 can establish a group trust level for the group of communication devices, when all the communication devices from the group of communication devices have previous knowledge about each other. This group trust level is broadcasted to the group of communication devices and corresponding data sharing settings are established. It is determined that all the communication devices from the group of communication devices have previous knowledge about each other, when any two communication devices in the group have previous knowledge of each other. In other words, these communication devices have some historical data associated with them. When a substantial number of communication devices from the group of communication devices do not have previous knowledge of each other, then the first communication device 104 can establish a default trust level for the group of communication devices. These substantial number of communication devices do not have previous knowledge of each other when the number of pairs of communication devices having no associated historical data between them, is above a predefined value. When a substantial number of communication devices from the group of communication devices have previous knowledge of each other, the first communication device 104 can establish a trust level for the group of communication devices by using the query-response technique. In other words, the trust level is established when the number of pairs of communication devices having no associated historical data between them, is below the predefined value.

At step 510, a request is sent by the first communication device 104 to the communication device 110 to update the group trust level. The group trust level needs to be updated when the first trust level is modified. The change in the first trust level can affect the group trust level. In an embodiment, the group trust level is updated when the second communication device 108 leaves the group of communication devices. In another embodiment, the group trust level is updated when the communication device 110, which is the initiator, leaves the group of communication devices. In this case, a communication device, for example, the communication device 106, is appointed as the new initiator. In an embodiment, the communication device 106 is the highest trusted device among the group of communication devices. In another embodiment, the communication device 106 is appointed based on the order in which the communication device 106 has joined the group of communication devices. At step 512, the updated trust level that is broadcasted by the communication device 110 is received by the first communication device 104. At step 514, the method 500 is terminated.

Various embodiments of the present invention provide a method and system for communicating in a group of communication devices. The present invention provides a secure method for communication in an ad-hoc group of communication devices. The method involves establishing, maintaining, and using the history of previous communications and configuration settings for communication sessions of the ad-hoc group of communication devices. In other words, the trust level that determines the nature of communication among the group of communication devices can be dynamically modified using the history of previous communications among these communication devices. The present invention involves automated modification of the trust level when establishing a communication session within an ad-hoc group of communication devices, for example, a social group. The modification of the trust level is based on the history of the previous communication among the social group. The trust level can also be modified dynamically while the communication within the social group is taking place. The trust level is also modified as the members of the social group join or leave the social group. For example, when a communication session is initiated within the social group, the history of the previous communications within the social group is analyzed along with the profiles of the members of the social group. A corresponding configuration and profile is set for this communication session based on this analysis. This configuration and profile determines the security and the trust level of the communication and the nature of content shared during the communication session.

The method for communicating in a group of communication devices, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit, and the Internet. The computer comprises a microprocessor. The microprocessor is connected to a communication bus. The computer also includes a memory. The memory may include a Random Access Memory (RAM) and a Read Only Memory (ROM). The computer system also comprises a storage device, which can be a hard disk drive or a removable storage drive such as a floppy disk drive, an optical disk drive, and the like. Further, the storage device can be other similar means for loading computer programs or other instructions into the computer system.

The computer system executes a set of instructions that are stored in one or more storage elements, to process input data. The storage elements may also hold data or other information, as desired. The storage elements may be in the form of an information source or a physical memory element present in the processing machine.

The process shown in FIGS. 4 and 5 may be implemented in a general, multi-purpose or single-purpose processor. Such a processor will execute instructions, either at the assembly, compiled or machine level, to perform the process. Those instructions can be written by one with ordinary skill in the art, following the description of FIGS. 4 and 5, and stored or transmitted on a computer-readable medium. The instructions may also be created by using a source code or any other known computer-aided design tool. A computer-readable medium may be any medium that is capable of carrying out these instructions and can include a CD-ROM, DVD, a magnetic or other optical disc, a tape, a silicon memory (removable, non-removable, volatile or non-volatile), a packetized or non-packetized wireline, or wireless transmission signals.

The set of instructions may include various commands that instruct the processing machine to perform specific tasks such as the steps that constitute the method of the present invention. The set of instructions may be in the form of a software program. The software may be in various forms such as a system software or an application software. Further, the software may be in the form of a collection of separate programs, a program module with a larger program, or a portion of a program module. The software may also include modular programming in the form of object-oriented programming. The processing of input data by the processing machine may be in response to user commands, to the results of previous processing, or to a request made by another processing machine.

It will be appreciated that the method and system for communicating in a group of communication devices, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method and system for communicating in a group of communication devices. Alternatively, some or all the functions can be implemented by a state machine that has no stored program instructions, or in one or more application-specific integrated circuits (ASICs), in which each function, or some combinations of certain functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims below. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for communicating in a group of communication devices in a network, the method at a first communication device comprising:
receiving a first trust level change request from a second communication device, wherein the first trust level is associated with the first communication device and the second communication device, further wherein a group trust level is associated with the group of communication devices; and
modifying the first trust level based on historical data associated with the first communication device and the second communication device, wherein the historical data is a function of at least one of duration of communication, frequency of the communication, and content of data exchanged, between the first communication device and the second communication device.

2. The method as recited in claim 1 further comprising sending a request to a third communication device for updating the group trust level.

3. The method as recited in claim 2, wherein the third communication device is a server.

4. The method as recited in claim 2 further comprising receiving the updated group trust level broadcasted by the third communication device.

5. The method as recited in claim 2 further comprising receiving enquiry messages from a third communication device to verify presence of the second communication device.

6. The method as recited in claim 1, wherein the first trust level change request is received when the second communication device sends a request to the first communication device for one of:
joining the group of communication devices; and
leaving the group of communication devices.

7. The method as recited in claim 1, wherein the communication among the group of communication devices is managed by a third communication device.

8. The method as recited in claim 7, wherein the third communication device is one of the first communication device and the second communication device.

9. The method as recited in claim 8 further comprising receiving a notification of the appointment of a communication device from the group of communication devices for managing the communication among the group of communication devices when the third communication device leaves the group.

10. The method as recited in claim 9, wherein the appointment of the communication device is based on comparison of individual trust levels associated among the group of communication devices.

11. The method as recited in claim 9, wherein the communication device is appointed based on the order in which the communication device joins the group of communication devices.

12. The method as recited in claim 8 further comprising receiving approval messages from the group of communication devices regarding the appointment of the communication device, prior to the appointment, when the third communication device provides a notification of leaving the group.

13. The method as recited in claim 7 further comprising configuring the group trust level as a default trust level when number of pairs of communication devices with no associated historical data is above a pre-defined value.

14. The method as recited in claim 7 further comprising configuring the group trust level based on a query-response technique, when number of pairs of communication devices with no associated historical data is below a pre-defined value.

15. The method as recited in claim 7 further comprising establishing data sharing settings for the group of communication devices, wherein the data sharing settings are established based on the group trust level.

16. The method as recited in claim 1, wherein the group trust level is a minimum trust level among the individual trust levels associated among the group of communication devices.

17. A first communication device comprising:
a receiver, wherein the receiver is configured to receive a first trust level change request from a second communication device from a group of communication devices, wherein the first trust level is associated with the first communication device and the second communication device;
a processor operatively coupled to the receiver, wherein the processor is configured to modify the first trust level based on historical data associated with the first communication device and the second communication device, wherein the historical data is a function of at least one of duration of communication, frequency of the communication, and content of data exchanged between the first communication device and the second communication device; and
a transmitter operatively coupled to the processor, wherein the transmitter is configured to send a request to a third communication device for updating a group trust level associated with the group of communication devices.

18. The first communication device as recited in claim 17 further comprising a memory operatively coupled to the processor, wherein the memory is configured to store the historical data.

19. The first communication device as recited in claim 17, wherein the receiver is further configured to receive a notification of the appointment of a communication device from the group of communication devices for managing the communication among the group of communication devices when the third communication device leaves the group.

20. The first communication device as recited in claim 17, wherein the receiver is further configured to receive enquiry messages from the third communication device to verify presence of the second communication device.

21. The first communication device as recited in claim 17, wherein the receiver is further configured to receive an approval message from the group of communication devices regarding the appointment of a communication device from the group of communication devices for managing the communication among the group of communication devices.

22. The first communication device as recited in claim 17, wherein the processor is further configured to update the group trust level.

23. The first communication device as recited in claim 22, wherein the processor updates the group trust level based on a query-response technique.

24. The first communication device as recited in claim 17, wherein the processor is further configured to appoint a communication device from the group of communication devices for managing the communication among the group of communication devices when the first communication device leaves the group.

25. A server for managing communication in a group of communication devices in a network, the server comprising:
a receiver configured to receive a group trust level change request from a first communication device, wherein the group trust level change request is generated by the first communication device based on historical data associated with the first communication device and a second communication device, further wherein the historical data is a function of at least one of duration of communication, frequency of the communication, and content of data exchanged between the first communication device and the second communication device;
a processor operatively coupled to the receiver, wherein the processor is configured to update a group trust level based on the comparison of individual trust levels associated among the group of communication devices, wherein the group trust level is associated with the group of communication devices; and
a transmitter operatively coupled to the processor, wherein the transmitter is configured to broadcast the updated group trust level to the group of communication device.

26. The server as recited in claim 25 further comprising a memory operatively coupled to the processor, wherein the memory is configured to store the historical data.

27. The server as recited in claim 25, wherein the receiver is further configured to receive a request from the first communication device to access the historical data.

28. The server as recited in claim 25, wherein the processor is further configured to update the historical data based on the change in a first trust level associated with the first communication device and the second communication device.

29. The server as recited in claim 25, wherein the processor is further configured to establish the data sharing settings for the group of communication devices based on the group trust level.
